(19) United States
(12) Patent Application Publication
(10) Pub. No.: US 2010/0305862 A1
(43) Pub. Date: Dec. 2, 2010

(54) BOREHOLE COMPENSATED RESISTIVITY LOGGING TOOL HAVING AN ASYMMETRIC ANTENNA SPACING

(75) Inventor: Jing Li, Sugar Land, TX (US)

Correspondence Address: SMITH INTERNATIONAL INC.;Patent Services, 1310 Rankin Rd., HOUSTON, TX, 77073, US

(73) Assignee: Smith International, Inc., Houston, TX (US)

(21) Appl. No.: 12/476,868

(22) Filed: Jun. 2, 2009

(51) Int. Cl. G01V 3/30; G06F 19/00

(52) U.S. Cl. 702/7; 324/338

(57) ABSTRACT

A compensated resistivity logging while drilling tool having axially asymmetrically spaced transmitters is configured to provide compensated resistivity measurements. In one exemplary embodiment, the tool includes first and second compensating transmitters, preferably deployed axially symmetrically between first and second spaced receivers. The tool further includes a plurality of transmitters deployed axially asymmetrically with respect to the receivers, e.g., on one axial side of the receivers. The compensating transmitters are configured to acquire a borehole compensation that may be subtracted from conventional phase and attenuation measurements.

### RELATED APPLICATIONS

None.

### FIELD OF THE INVENTION

The present invention relates generally to downhole measurement tools utilized for measuring electromagnetic properties of a subterranean borehole. More particularly, the invention relates to borehole compensated resistivity logging tools having asymmetric transmitter spacing along the longitudinal axis of the tool.

### BACKGROUND OF THE INVENTION

The use of electrical measurements in prior art downhole applications, such as logging while drilling (LWD), measurement while drilling (MWD), and wireline logging applications is well known. Such techniques may be utilized to determine a subterranean formation resistivity, which, along with formation porosity measurements, is often used to indicate the presence of hydrocarbons in the formation. For example, it is known in the art that porous formations having a high electrical resistivity often contain hydrocarbons, such as crude oil, while porous formations having a low electrical resistivity are often water saturated. It will be appreciated that the terms resistivity and conductivity are often used interchangeably in the art. Those of ordinary skill in the art will readily recognize that these quantities are reciprocals and that one may be converted to the other via simple mathematical calculations. Mention of one or the other herein is for convenience of description, and is not intended in a limiting sense.

Formation resistivity (or conductivity) is commonly measured by transmitting an electromagnetic wave through a formation using a length of antenna wire wound about a downhole tool. As is well known to those of ordinary skill in the art, a time varying electric current (an alternating current) in a transmitting antenna produces a corresponding time varying magnetic field in the formation. The magnetic field in turn induces electrical currents (eddy currents) in a conductive formation. These eddy currents further produce secondary magnetic fields which may produce a voltage response in a receiving antenna. The measured voltage in the receiving antennae can be processed, as is known to those of ordinary skill in the art, to obtain one or more measurements of the secondary magnetic field, which may in turn be further processed to estimate formation resistivity (conductivity) and/or dielectric constant. These electrical formation properties can be further related to the hydrocarbon bearing potential of the formation via techniques known to those of skill in the art.

It is also well known that a transmitted electromagnetic wave is typically both attenuated and phase shifted by an amount related to the resistivity and/or dielectric constant of the formation. The transmitted wave is commonly received at first and second spaced receiving antennae. The attenuation and phase shift between the first and second receivers are commonly acquired by taking a ratio of the received waves. The attenuation and/or phase shift may then be utilized to estimate the formation resistivity. In order to acquire more data, e.g., at multiple depths of investigation into the formation, it is well known to make the above measurements using multiple spaced transmitters since the depth of penetration of an electromagnetic wave into the formation tends to increase with increased spacing between the transmitter and receiver. The use of multiple perturbation frequencies is also a known means of investigating multiple depths of investigation since the depth of penetration tends to be inversely related to the frequency of the propagated electromagnetic waves.

In order to accommodate errors introduced by the receiver electronics (e.g., due to thermal drift downhole), conventional resistivity measurements commonly employ a compensation scheme. One such compensation technique is to configure a resistivity tool with symmetric transmitters (i.e., with the transmitters deployed axially symmetrically about the receivers). FIG. 1 depicts a well known and commercially available prior art resistivity tool 50 employing such compensation. The tool embodiment depicted includes first and second receivers R₁ and R₂ deployed symmetrically between first and second sets of transmitters T₁, T_{2, T}_{3 and T}₁′ T₂′, T₃′. The transmitters are fired sequentially and the results from each of the transmitter pairs (T₁ and T₁′, T₂ and T₂′, T₃ and T₃′) may be averaged to essentially cancel out the error term. While this approach is commercially viable, one drawback is that it results in a significantly increased tool length. The increased tool length results in other sensors being located further from the bit. Increased tool length can also be problematic in high dogleg severity wells.

U.S. Pat. No. 6,218,842 discloses an alternative compensation scheme in which a single compensating transmitter is deployed axially between the receivers. During drilling operations, the calibrating transmitter generates an electromagnetic wave that is detected by each of the receivers. The difference in attenuation and phase shift between the detected signals is used to calibrate the receivers for thermal drift. While this approach may overcome the above described problems, it requires that the calibrating transmitter be located precisely between the receivers. Any errors in placement (or tool body deformation due to the extreme borehole temperature and pressure) can result in significant calibration errors.

Therefore, there remains a need in the art for further improved resistivity logging tools, and in particular improved compensation schemes for such resistivity logging tools.

### SUMMARY OF THE INVENTION

Aspects of the present invention are intended to address the above described need for an improved resistivity logging tool. In one aspect the present invention includes a logging while drilling resistivity tool having a plurality of spaced transmitters deployed on one axial side of first and second receivers. The tool further includes first and second compensating transmitters, preferably deployed symmetrically between the receivers. The compensating transmitters may be used to acquire a borehole compensation (phase and attenuation errors) that may be subtracted from the conventional phase and attenuation measurements.

Exemplary embodiments of the present invention advantageously provide several technical advantages. For example, exemplary embodiments of the invention advantageously provide for accurate borehole compensation while also providing for a significant reduction in the overall tool length. Tools in accordance with the invention therefore tend to be better suited for high dogleg severity wells and also provide for a more compact BHA.

In one aspect, the present invention includes a logging while drilling resistivity tool. The tool includes a logging while drilling tool body having first and second longitudinally spaced receivers deployed thereon. First and second longitudinally spaced compensating transmitters are deployed axially between the first and second receivers. The compensating transmitters are axially symmetric about a midpoint between the first and second receivers. A plurality of longitudinally spaced transmitters is also deployed on the tool body, the plurality of transmitters being asymmetric with respect to the midpoint. In a preferred embodiment the resistivity tool further includes a controller configured to (i) utilize the first and second compensating transmitters to obtain at least one of an attenuation error and a phase error at the receivers and (ii) subtract the attenuation error and/or phase error from subsequent attenuation and phase measurements made with at least one of the plurality of transmitters and the first and second receivers.

In another aspect, the present invention includes a method for compensating resistivity measurements made in a subterranean borehole. The method includes deploying a resistivity tool in the borehole. The tool includes first and second longitudinally spaced receivers, first and second longitudinally spaced compensating transmitters (the compensating transmitters being axially symmetric about a midpoint between the first and second receivers), and a plurality of longitudinally spaced transmitters. The method further includes causing the first and second compensating transmitters to transmit corresponding first and second compensating electromagnetic waves, measuring a phase shift and an attenuation between the first and second receivers for each of the first and second compensating electromagnetic waves, and computing a phase shift error and an attenuation error from the measured phase shifts and attenuations. The method still further includes causing at least one of the transmitters to transmit an electromagnetic wave, measuring a phase shift and an attenuation between the first and second receivers, and subtracting the computed phase shift error and attenuation error from the measured phase shift and attenuation to obtain a compensated phase shift and attenuation.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a prior art compensated LWD resistivity tool employing symmetric sets of transmitters.

FIG. 2 depicts one exemplary embodiment of an asymmetric LWD resistivity tool in accordance with the present invention.

FIG. 3 depicts another exemplary embodiment of an asymmetric LWD resistivity tool in accordance with the present invention.

FIG. 4 depicts one exemplary method embodiment in accordance with the present invention in flow chart form.

### DETAILED DESCRIPTION

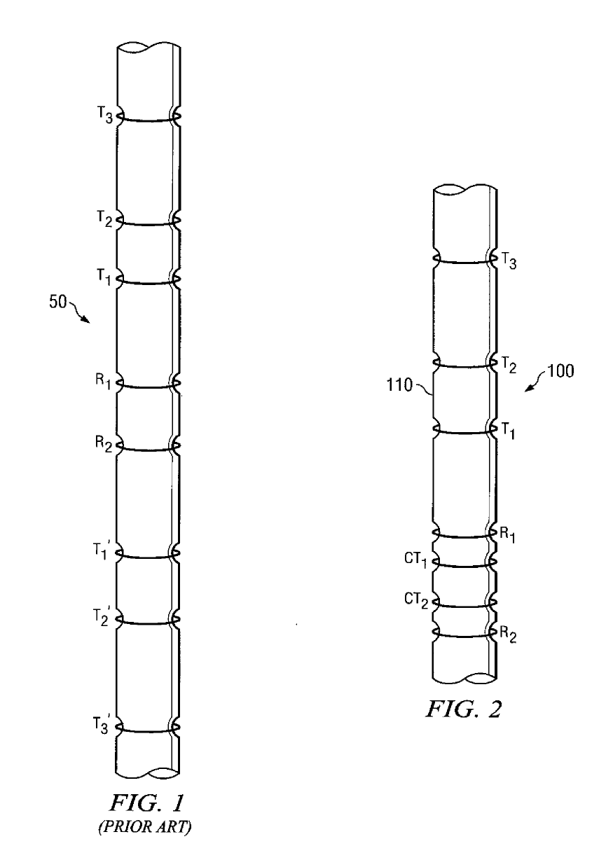

FIG. 2 depicts one exemplary embodiment of an LWD resistivity tool 100 in accordance with the present invention. Resistivity tool 100 includes a plurality of spaced transmitters T₁, T₂, and T₃ and a pair of spaced receivers R₁ and R₂ deployed about a tool body 110. The transmitters T₁, T₂, and T₃ may be thought of as being asymmetric in that they are deployed on one axial side of the receiver pair R₁ and R₂ and in that there are no corresponding symmetric transmitters deployed on the opposite axial side of the receivers. In contrast to the prior art resistivity tool 50 depicted on FIG. 1, the present invention does not include a second set of symmetric transmitters. Resistivity tool 100 further includes a pair of symmetric compensating transmitters CT₁ and CT₂. In the exemplary embodiment depicted on FIG. 2, these compensating transmitters CT₁ and CT₂ are deployed axially between the receiver pair R₁ and R₂. While the invention is not limited in this regard (the compensating transmitters may also be deployed axially about the receivers), deployment of the compensating transmitters CT₁ and CT₂ between the receiver pair R₁ and R₂ is preferred in that it advantageously minimized tool length.

With continued reference to FIG. 2, the compensating transmitters CT₁ and CT₂ are configured to synthesize a suitable borehole compensation. This compensation may then be removed from the uncompensated measurements acquired using the spaced transmitters T₁, T₂, and T₃ and receivers R₁ and R₂. During drilling, the compensating transmitters CT₁ and CT₂ may be fired sequentially at any suitable time interval to generate corresponding electromagnetic waves in the formation. These waves are received by each of the receivers R₁ and R₂ and utilized to compute the borehole compensation. The compensating transmitters CT₁ and CT₂ may be energized with an alternating electrical current having the same or opposite sign. The invention is not limited in these regards.

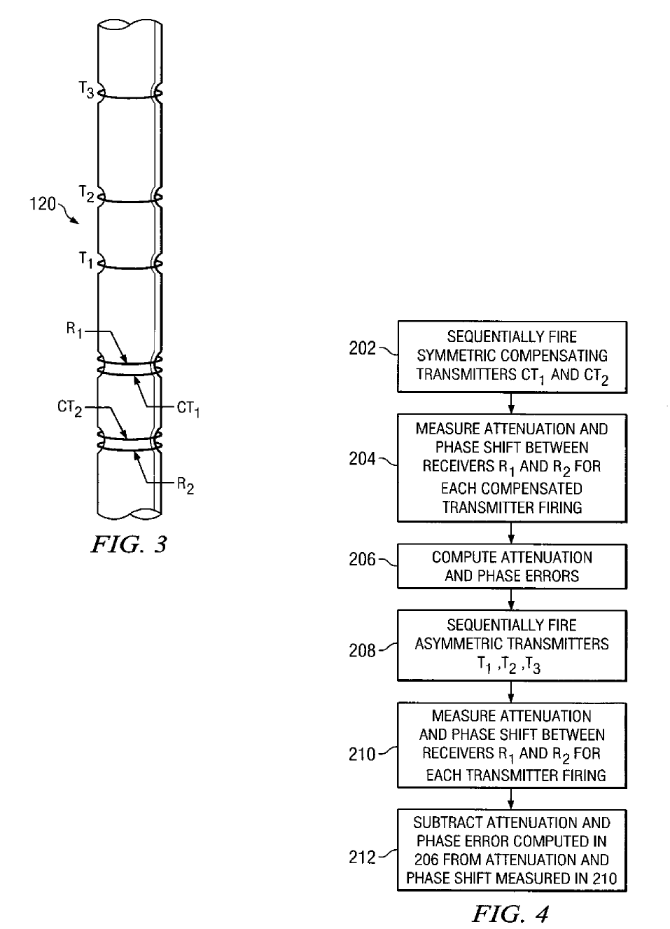

FIG. 3 depicts an alternative resistivity tool embodiment 150 in accordance with the present invention in which the compensating transmitters CT₁ and CT₂ are deployed in the same grooves as corresponding receivers R₁ and R₂. Such an embodiment advantageously reduces the number of grooves in the tool body and therefore tends to reduce manufacturing costs and conserve tool strength. It will be appreciated that the invention is not limited to the exemplary tool embodiments depicted on FIGS. 2 and 3. For example, in other alternative tool embodiments the compensating transmitters CT₁ and CT₂ may also be deployed axially about the receivers (as opposed to axially between). The invention is not limited in these regards.

Those of ordinary skill in the art will readily appreciate that the magnetic field obtained from a received electromagnetic wave differs from the true magnetic field in the formation due to several environmental factors (e.g., including temperature drift, antenna deformation, and other electronic errors in the receiver). This distortion may be represented mathematically, for example, as follows:

H*(ω)=A(ω)e^{iΔφ}H(ω) Equation 1

where H*(ω) represents the measured magnetic field, H (ω) represents the true magnetic field in the formation, A(ω) and Δφ represent the amplitude and phase distortion of the true formation magnetic field, and ω represents the angular frequency of the electromagnetic wave in units of radians. When the compensating transmitters CT₁ and CT₂ are fired sequentially as described above, the measured magnetic fields at each of the receivers R₁ and R₂ may be represented mathematically in similar form, for example, as follows:

H*_{CT1R1}(ω)=CT₁(ω)A_{R1}(ω)e^{iΔφ}^{_{R1}}H_{CT1R1}(ω)

H*_{CT1R2}(ω)=CT₁(ω)A_{R2}(ω)e^{iΔφ}^{_{R2}}H_{CT1R2}(ω)

H*_{CT2R1}(ω)=CT₂(ω)A_{R1}(ω)e^{iΔφ}^{_{R1}}H_{CT2R1}(ω)

H*_{CT2R2}(ω)=CT₂(ω)A_{R2}(ω)e^{iΔφ}^{_{R2}}H_{CT2R2}(ω) Equation 2

where H*_{CT1R1}(ω) and H*_{CT1R2}(ω) represent the measured magnetic fields at the first and second receivers R₁ and R₂ induced by firing the first compensating transmitter CT₁, H*_{CT2R1}(ω) and H*_{CT2R2}(ω) represent the measured magnetic fields at the first and second receivers R₁ and R₂ induced by firing the second compensating transmitter CT₂, H_{CT1R1}(ω), H_{CT1R2}(ω), H_{CT2R1}(ω), and H_{CT2R2}(ω) represent the corresponding true magnetic fields in the formation, A_{R1}(ω), A_{R2}(ω) and Δφ_{R1}, Δφ_{R2} represent the amplitude and phase distortion of the true formation magnetic field at each of the receivers, and CT₁(ω) and C_{T2}(ω) account for any transmitter moment variations.

By following the standard procedure of taking the ratio of the far-receiver measurement to the near-receiver measurement, the response for each transmitter, H*_{CT1}(ω) and H*_{CT2}(ω) may be represented mathematically, for example, as follows:

$${H}_{CT 1}^{*} ( ω ) = \frac{{H}_{CT 1 R 2}^{*} ( ω )}{{H}_{CT 1 R 1}^{*} ( ω )} \\ = \frac{{A}_{R 2} ( ω )}{{A}_{R 1} ( ω )} {e}^{i ( Δ {φ}_{R 2} - Δ {φ}_{R 1} )} \frac{{H}_{CT 1 R 2} ( ω )}{{H}_{CT 1 R 1} ( ω )} \\ {H}_{CT 2}^{*} ( ω ) = \frac{{H}_{CT 2 R 1}^{*} ( ω )}{{H}_{CT 2 R 2}^{*} ( ω )} \\ = \frac{{A}_{R 1} ( ω )}{{A}_{R 2} ( ω )} {e}^{i ( Δ {φ}_{R 1} - Δ {φ}_{R 2} )} \frac{{H}_{CT 2 R 1} ( ω )}{{H}_{CT 2 R 2} ( ω )} \qquad Equation 3$$

The system noise (error) in both amplitude and phase as measured by the compensating transmitters may then be represented as the square root of the ratio of H*_{CT1}(ω) to H*_{CT2}(ω). This may be represented mathematically, for example, as follows:

$$CTH ( ω ) = \sqrt{\frac{{H}_{CT 1}^{*} ( ω )}{{H}_{CT 2}^{*} ( ω )}} = \vert \frac{{A}_{R 2} ( ω )}{{A}_{R 1} ( ω )} \vert {e}^{i ( {Δφ}_{R 2} - Δ {φ}_{R 1} )} \qquad Equation 4$$

where the attenuation error is A_{E}=A_{R2}(ω)/A_{R1}(ω) and the phase error is Δφ_{E}=Δφ_{R2}−Δφ_{R1}.

Based on Equations 3 and 4, the amplitude and phase error can be readily obtained from the compensating transmitter CT₁ and CT₂ firings. For example, with further reference now to FIG. 4, compensating transmitters CT₁ and CT₂ may be fired sequentially at 202 and the corresponding attenuation and phase shift between the receivers R₁ and R₂ measured for each compensating transmitter firing at 204. These may be represented mathematically, for example, as follows:

Δφ_{T1}=Δφ_{F}+Δφ_{E} and Δφ_{CT2}=Δφ_{F}−Δφ_{E} Equation 5

A_{CT1}(dB)=A_{F}(dB)+A_{E}(dB) and A_{CT2}(dB)=A_{F}(dB)−A_{E}(dB) Equation 6

where Δφ_{CT1} and Δφ_{CT2} represent the measured phase shifts for each compensating transmitter firing, A_{CT1}(dB) and A_{CT2}(dB) represent the measured attenuation in units of decibels for each compensating transmitter firing, Δφ_{F} and A_{F}(dB) represent the phase shift and attenuation (in decibels) in the absence of error, and Δφ_{E} and A_{E}(dB) represent the phase shift and attenuation (in decibels) errors. The phase shift and attenuation errors may be computed from the measured phase shift and attenuation at 206, for example, as follows:

$$\begin{matrix}Δ {φ}_{E} = \frac{Δ {φ}_{CT 1} - Δ {φ}_{CT 2}}{2} & Equation 5 \\ {A}_{E} ( dB ) = \frac{{A}_{CT 1} ( dB ) - {A}_{CT 2} ( dB )}{2} & Equation 6\end{matrix}$$

Although the compensating transmitters CT₁ and CT₂ have much shorter spacing than transmitters T₁, T₂, and T₃, the attenuation and phase errors tend to be essentially the same since these errors are primarily caused by the receiving antennae and their corresponding electronics. Therefore, the phase and attenuation errors obtained in Equations 7 and 8 via the firing of the compensating transmitters CT₁ and CT₂ may be removed (subtracted) from uncompensated measurements to obtain compensated measurements. For example, uncompensated measurements may be obtained via sequentially firing transmitters T₁, T₂, and T₃ of resistivity tool 100 at 208 and receiving the corresponding electromagnetic waves at receivers R₁ and R₂. These received waves may be processed at 210 to obtain measured phase shift and attenuation between the receivers R₁ and R₂ for each transmitter firing. The phase and attenuation errors obtained in 206 (e.g., via equations 7 and 8) may then be subtracted from the uncompensated measurements obtained in 210 to obtain compensated measurements at 212, for example, as follows:

Δφ_{C1}=Δφ_{T1}−Δφ_{E} and A_{C1}(dB)=A_{T1}(dB)−A_{E}(dB)

Δφ_{C2}=Δφ_{T2}−Δφ_{E} and A_{C2}(dB)=A_{T2}(dB)−A_{E}(dB)

Δφ_{C3}=Δφ_{T3}−Δφ_{E} and A_{C3}(dB)=A_{T3}(dB)−A_{E}(dB) Equation 9

where Δφ_{C1}, Δφ_{C2}, Δφ_{C3}, A_{C1}(dB), A_{C2}(dB), and A_{C3}(dB) represent the compensated phase and attenuation measurements obtained in accordance with exemplary embodiments of the present invention and Δφ_{T1}, Δφ_{T2}, Δφ_{T3}, A_{T1}(dB), A_{T2}(dB), and A_{T3}(dB) represent the uncompensated phase and attenuation measurements obtained from firing the asymmetric transmitters T₁, T₂, and T₃.

The above described apparatus and method advantageously tend to provide for accurate error compensation. In particular, the methodology tends to be relatively insensitive to the positioning of the compensating transmitters CT₁ and CT₂. While a symmetric configuration is preferred, errors in placement or tool body deformation due to the extreme borehole temperature and pressure encountered downhole advantageously tend not to significantly affect the measured phase and attenuation errors. This is because the errors that result from such positional uncertainty tend to cancel out. Those of skill in the art will appreciate that the phase errors are obtained by subtraction in Equations 7 and 8. Therefore, further errors caused by a position change in the first compensating transmitter tend cancel those caused by a position change in the second compensating transmitter. This represents a significant improvement over the '842 patent described above.

With reference again to FIGS. 2 and 3, measurement tools 100 and 120 may further include a controller (not shown) having, for example, a programmable processor (not shown), such as a microprocessor or a microcontroller, and may also include processor-readable or computer-readable program code embodying logic, including instructions for controlling the function of the measurement tool 100, 120. A suitable controller may be utilized, for example, to execute method 200 (FIG. 4). As such, the controller may be configured to cause (i) the compensating transmitters to fire and (ii) the receivers to measure corresponding attenuation and phase shift for each transmitter firing. The controller may also include instructions for computing an attenuation and phase error from these measurements. A suitable controller may also be configured to cause (iii) the asymmetric transmitters to fire and (iv) the receivers to measure corresponding attenuation and phase shift for each firing. The controller may further include instructions for removing the attenuation and phase error from the measured attenuation and phase shift.

A suitable controller may also optionally include other controllable components, such as sensors, data storage devices, power supplies, timers, and the like. The controller may also be disposed to be in electronic communication with various other sensors and/or probes for monitoring physical parameters of the borehole, such as a gamma ray sensor, a depth detection sensor, or an accelerometer, gyro or magnetometer to detect azimuth and inclination. A controller may also optionally communicate with other instruments in the drill string, such as telemetry systems that communicate with the surface. A controller may further optionally include volatile or non-volatile memory or a data storage device.

A suitable controller typically also includes conventional electronics utilized in transmitting and/or receiving an electromagnetic waveform. For example, the controller may include conventional electronics such as a variable gain amplifier for amplifying a relatively weak return signal (as compared to the transmitted signal) and/or various filters (e.g., low, high, and/or band pass filters), rectifiers, multiplexers, and other circuit components for processing the return signal. A suitable controller also typically includes conventional electronics for determining the amplitude and phase of a received electromagnetic wave as well as the attenuation and phase change between the first and second receivers. Such electronic systems are well known and conventional in the art.

Although the present invention and its advantages have been described in detail, it should be understood that various changes, substitutions and alternations can be made herein without departing from the spirit and scope of the invention as defined by the appended claims.

I claim:

1. A logging while drilling resistivity tool comprising:
a logging while drilling tool body;
first and second longitudinally spaced receivers deployed on the tool body;
first and second longitudinally spaced compensating transmitters deployed axially between the first and second receivers, the compensating transmitters being axially symmetric about a midpoint between the first and second receivers; and
a plurality of longitudinally spaced transmitters deployed on the tool body, the plurality of transmitters being asymmetric with respect to the midpoint.

2. The tool of claim 1, wherein each of the plurality of transmitters is deployed on a first axial side of the first and second receivers.

3. The tool of claim 2, wherein there are no transmitters deployed on an opposing second axial side of the first and second receivers.

4. The tool of claim 1, wherein:
the first receiver and the first compensating transmitter are deployed in a first circumferential groove in the tool body; and
the second receiver and the second compensating transmitter are deployed in a second circumferential groove in the tool body.

5. The tool of claim 1, wherein each of the receivers, each of the compensating transmitters, and each of the plurality of transmitters comprises a loop antenna and electronic circuitry configured to transmit and/or receive an electromagnetic wave.

6. The tool of claim 1, further comprising a controller configured to:
utilize the compensating transmitters to determine at least one of an attenuation error and a phase error; and
remove the attenuation error and/or phase error from subsequent attenuation and phase measurements made with at least one of the plurality of transmitters and the first and second receivers.

7. A logging while drilling resistivity tool comprising:
a logging while drilling tool body;
first and second longitudinally spaced receivers deployed on the tool body;
first and second longitudinally spaced compensating transmitters deployed on the tool body, the compensating transmitters being axially symmetric about a midpoint between the first and second receivers;
a plurality of longitudinally spaced transmitters deployed on the tool body, the plurality of transmitters being asymmetric with respect to the midpoint; and
a controller configured to: (i) utilize the first and second compensating transmitters to obtain at least one of an attenuation error and a phase error at the receivers, and (ii) subtract the attenuation error and/or phase error from subsequent attenuation and phase measurements made with at least one of the plurality of transmitters and the first and second receivers.

8. The tool of claim 7, wherein the first and second compensating transmitters are deployed axially between the first and second receivers.

9. The tool of claim 7, wherein:
the first receiver and the first compensating transmitter are deployed in a first circumferential groove in the tool body; and
the second receiver and the second compensating transmitter are deployed in a second circumferential groove in the tool body.

10. The tool of claim 7, wherein each of the plurality of transmitters is deployed on a first axial side of the first and second receivers.

11. The tool of claim 10, wherein there are no transmitters deployed on an opposing second axial side of the first and second receivers.

12. The tool of claim 7, wherein each of the receivers, each of the compensating transmitters, and each of the plurality of transmitters comprises a loop antenna and electronic circuitry configured to transmit and/or receive an electromagnetic wave.

13. The tool of claim 7, wherein the controller is configured to:
(i) cause the first and second compensating transmitters to transmit corresponding first and second compensating electromagnetic waves;
(ii) measure an attenuation and a phase shift between the first and second receivers for each of the first and second compensating electromagnetic waves;
(iii) compute an attenuation error and a phase error from the attenuations and phase shifts measured in (ii);
(iv) cause at least one of the plurality of transmitters to transmit an electromagnetic wave;
(v) measure an attenuation and a phase shift between the first and second receivers for the electromagnetic wave transmitted in (iv); and
(vi) subtract the attenuation error and the phase error computed in (iii) from the attenuation and phase shift measured in (v).

14. A method for compensating resistivity measurements made in a subterranean borehole, the method comprising:
(a) deploying a resistivity tool in the borehole; the tool including first and second longitudinally spaced receivers, first and second longitudinally spaced compensating transmitters, the compensating transmitters being axially symmetric about a midpoint between the first and second receivers, and a plurality of longitudinally spaced transmitters;
(b) causing the first and second compensating transmitters to transmit corresponding first and second compensating electromagnetic waves;
(c) measuring a phase shift and an attenuation between the first and second receivers for each of the first and second compensating electromagnetic waves;
(d) computing a phase shift error and an attenuation error from the phase shifts and attenuations measured in (c);
(e) causing at least one of the plurality of transmitters to transmit an electromagnetic wave;
(f) measuring a phase shift and an attenuation between the first and second receivers for the electromagnetic wave transmitted in (e); and
(g) subtracting the phase shift error and the attenuation error computed in (d) from the phase shift and attenuation measured in (f) to obtain a compensated phase shift and attenuation.

15. The method of claim 14, wherein the phase shift error and the attenuation error are computed in (d) according to the following equations:
$${A}_{E} ( dB ) = \frac{{A}_{CT 1} ( dB ) - {A}_{CT 2} ( dB )}{2}$$
$$Δ {φ}_{E} = \frac{Δ {φ}_{CT 1} - Δ {φ}_{CT 2}}{2}$$
wherein Δφ_{E} and A_{E}(dB) represent the phase shift error and the attenuation error Δφ_{CT1} and Δφ_{CT2} represent the phase shifts measured in (c) for the corresponding first and second electromagnetic waves, and A_{CT1}(dB) and A_{CT2}(dB) represent the attenuations measured in (c) for the corresponding first and second electromagnetic waves.

16. The method of claim 14, wherein the phase shift error and the attenuation error are subtracted in (g) according to the following equations:
Δφ_{C1}=Δφ_{T1}−Δφ_{E}
A_{C1}(dB)=A_{T1}(dB)−A_{E}(dB)
where Δφ_{C1} and A_{C1}(dB) represent the compensated phase shift and attenuation Δφ_{T1} and Δ_{T2}(dB) represent the phase shift and attenuation measured in (f), and Δφ_{E} and A_{E}(dB) represent the phase shift error and the attenuation error computed in (d).
